(19) United States
(12) Patent Application Publication
(10) Pub. No.: US 2024/0272964 A1
(43) Pub. Date: Aug. 15, 2024

(54) AUTOMATED PROCESSING OF DYNAMIC REQUESTS

(71) Applicant: Dell Products L.P., Round Rock, TX (US)

(72) Inventors: Shibi Panikkar, Bangalore (IN); Sisir Samanta, Bangalore (IN)

(21) Appl. No.: 18/110,203

(22) Filed: Feb. 15, 2023

(51) Int. Cl. G06F 9/54

(52) U.S. Cl. CPC G06F 9/542; G06F 9/547

(57) ABSTRACT

Methods, apparatus, and processor-readable storage media for automated processing of dynamic requests are provided herein. An example computer-implemented method includes: obtaining a dynamic request associated with one or more items; determining information for processing the dynamic request, wherein the information comprises at least one action corresponding to the dynamic request and a set of applications impacted by the at least one action; and sending a notification of the at least one action to each respective application in the set of applications, wherein at least one application in the set of applications causes one or more processes to be executed, based at least in part on the notification, to process the dynamic request.

### FIELD

The field relates generally to information processing systems, and more particularly to request processing in such systems.

### BACKGROUND

Organizations often implement complex systems to process requests in a format that was designed for static items. The format can have significant limitations when applied to requests related to complex and configurable technologies, including as-a-service technologies.

### SUMMARY

Illustrative embodiments of the disclosure provide techniques for automated processing of dynamic requests. An exemplary computer-implemented method includes obtaining a dynamic request associated with one or more items; determining information for processing the dynamic request, wherein the information comprises at least one action corresponding to the dynamic request and a set of applications impacted by the at least one action; and sending a notification of the at least one action to each respective application in the set of applications, wherein at least one application in the set of applications causes one or more processes to be executed, based at least in part on the notification, to process the dynamic request.

Illustrative embodiments can provide significant advantages relative to conventional request processing techniques. For example, technical problems associated with processing dynamic requests related to complex and configurable items are mitigated in one or more embodiments by deriving an object for a given dynamic request that is used to identify and execute a plurality of actions across different applications and/or services to automatically process the request.

These and other illustrative embodiments described herein include, without limitation, methods, apparatus, systems, and computer program products comprising processor-readable storage media.

### BRIEF DESCRIPTION OF THE DRAWINGS

FIG. 1 shows an information processing system configured for automated processing of dynamic requests in an illustrative embodiment.

FIG. 2 shows an example system architecture for automated processing of dynamic requests in an illustrative embodiment.

FIG. 3 shows an example of a processing object in an illustrative embodiment.

FIG. 4 shows a flow diagram of a process for automated processing of dynamic requests in an illustrative embodiment.

FIGS. 5 and 6 show examples of processing platforms that may be utilized to implement at least a portion of an information processing system in illustrative embodiments.

### DETAILED DESCRIPTION

Illustrative embodiments will be described herein with reference to exemplary computer networks and associated computers, servers, network devices or other types of processing devices. It is to be appreciated, however, that these and other embodiments are not restricted to use with the particular illustrative network and device configurations shown. Accordingly, the term “computer network” as used herein is intended to be broadly construed, so as to encompass, for example, any system comprising multiple networked processing devices.

As noted above, many organizations have developed large and complex systems, for example, to handle requests (e.g., related to order and supply chain workflows) in a particular format. Such systems often include hundreds of interconnected applications for processing such requests, such as applications pertaining to supply chains, revenue systems, reporting, etc. These “legacy” systems use workflows that rely on specific parameters (e.g., an order number and/or order details), whereas processes and lifecycles related to configurable items often use different parameters (e.g., subscriptions that use subscription identifiers and subscription details).

This can be particularly challenging for an organization seeking to implement models (e.g., as-a-service models) related to configurable items alongside their traditional workflows and applications. As a non-limiting example, an organization in a manufacturing industry generally must decide whether to update the existing order flow to a flow that can process requests for configurable items and/or develop an entirely new flow for such items. Each option requires substantial amounts of time and resources. For example, developing a new flow in a large organization can take many months, or possibly even years, before it can be implemented. Maintaining separate systems for the same product is also inefficient as it can increase the number of resources (e.g., hardware resources) that are needed to develop, test, deploy, and manage such systems.

Some features related to configurable items (such as management actions for an existing subscription) are not well supported by conventional order-based systems. As an example, if an existing subscription includes 200 licenses for a “silver” storage plan and a request is received to upgrade 50 of the licenses to a “gold” storage plan, then two requests should generally be created. The first request is to remove 50 licenses from the silver plan, and the second request is to create a new subscription for a gold plan with 50 licenses. However, legacy systems do not support removing users from such a plan. A partial cancellation is generally only possible prior to the order being marked closed, which in many cases occurs soon after the order is placed. Additionally, once the order is marked closed in the legacy system, then the subscription cannot be canceled.

These issues are typically addressed using complex and inefficient techniques. For example, some conventional techniques accept the change request as an “order,” and then create multiple rules for different applications and/or systems (e.g., a sales system, an order management system, and/or a subscription system) for different order types and/or offer attributes. Accordingly, in the upgrade example above, such a system can flag the order to upgrade the 50 users using an upgrade flag and a subscription ID. The system may then apply one or more rules based on the flag. This approach can require changing substantially all of the applications in the workflow. For example, the rule may include: removing 50 users from the existing subscription; creating a new subscription for the new plan with 50 users; updating the revenue system, licensing system, and services system to account for the removal of the users; and creating a fulfilment order for the change of subscription quantity and subscription offer.

Another approach is to accept the request as a set of management actions in the subscription system for an existing subscription. The system can then create numerous rules for different types of orders to satisfy the different ordering applications (e.g., revenue recognition, manufacturing, fulfilment, business reporting, and/or support system).

Each of these approaches have one or more of the following disadvantages: results in nonstandard provisioning logic (e.g., the current subscription offer quantity cannot be identified from the upgrade request as the order will have only the quantity of the new offer); results in nonstandard revenue recognition logic (e.g., cannot easily reference the number of licenses associated with a subscription as the subscription corresponds to multiple orders, thereby making it more difficult to properly cancel the subscription, if needed); and/or causes issues with fulfilment and/or manufacturing processes (e.g., a new order with an upgrade flag will only indicate additional quantity to manufacture and provision, but this will not give an indication of assets and licenses which will require deprovisioning).

At least some embodiments described herein provide techniques that allow traditional order-based systems to automatically process dynamic requests in an efficient manner. Such embodiments can obtain a dynamic request in an existing format (e.g., an “order” based format), and then process the dynamic request without disrupting or needing to update the existing application flows. The term “dynamic request” as used in this context and elsewhere herein is intended to be broadly construed so as to encompass, for example, a request related to acquiring one or more items, such as products and/or services (for example, as-a-service technologies), as well as requests associated with one or more subscriptions or other ongoing, recurring and/or reoccurring requests. Processing a given dynamic request can involve creating and/or modifying data associated with such services, potentially across multiple applications.

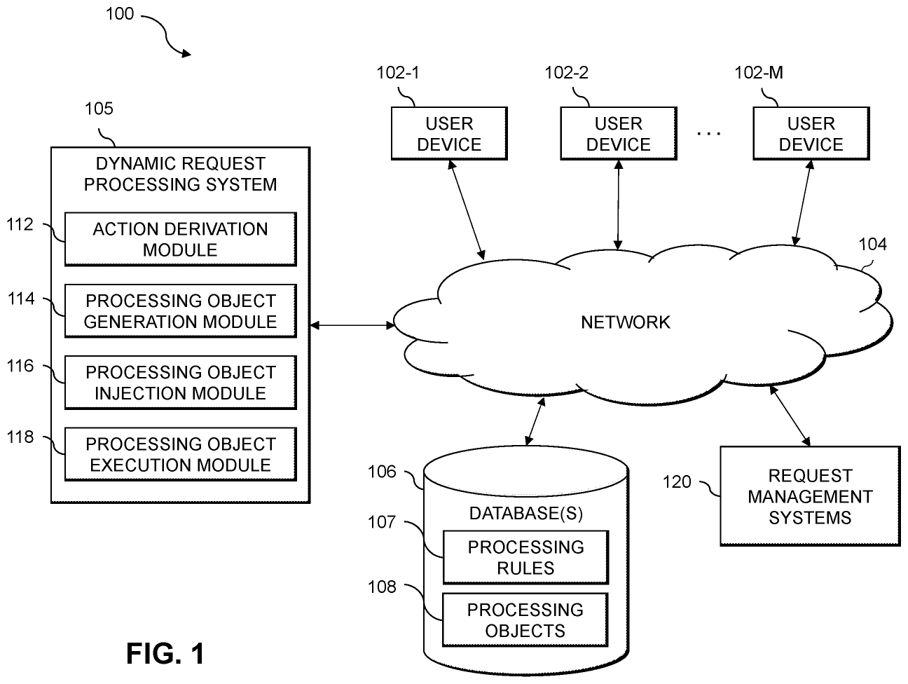

FIG. 1 shows a computer network (also referred to herein as an information processing system) 100 configured in accordance with an illustrative embodiment. The computer network 100 comprises a plurality of user devices 102-1, 102-2, . . . 102-M, collectively referred to herein as user devices 102. The user devices 102 are coupled to a network 104, where the network 104 in this embodiment is assumed to represent a sub-network or other related portion of the larger computer network 100. Accordingly, elements 100 and 104 are both referred to herein as examples of “networks,” but the latter is assumed to be a component of the former in the context of the FIG. 1 embodiment. Also coupled to network 104 is a dynamic request processing system 105, and optionally one or more request management systems 120.

The user devices 102 may comprise, for example, servers and/or portions of one or more server systems, as well as devices such as mobile telephones, laptop computers, tablet computers, desktop computers or other types of computing devices. Such devices are examples of what are more generally referred to herein as “processing devices.” Some of these processing devices are also generally referred to herein as “computers.”

The user devices 102 in some embodiments comprise respective computers associated with a particular company, organization or other enterprise. In addition, at least portions of the computer network 100 may also be referred to herein as collectively comprising an “enterprise network.” Numerous other operating scenarios involving a wide variety of different types and arrangements of processing devices and networks are possible, as will be appreciated by those skilled in the art.

Also, it is to be appreciated that the term “user” in this context and elsewhere herein is intended to be broadly construed so as to encompass, for example, human, hardware, software or firmware entities, as well as various combinations of such entities.

The network 104 is assumed to comprise a portion of a global computer network such as the Internet, although other types of networks can be part of the computer network 100, including a wide area network (WAN), a local area network (LAN), a satellite network, a telephone or cable network, a cellular network, a wireless network such as a Wi-Fi or WiMAX network, or various portions or combinations of these and other types of networks. The computer network 100 in some embodiments therefore comprises combinations of multiple different types of networks, each comprising processing devices configured to communicate using internet protocol (IP) or other related communication protocols.

Additionally, the dynamic request processing system 105 can have at least one associated database 106 configured to store data pertaining to, for example, processing rules 107 and/or processing objects 108.

An example database 106, such as depicted in the present embodiment, can be implemented using one or more storage systems associated with the dynamic request processing system 105. Such storage systems can comprise any of a variety of different types of storage including network-attached storage (NAS), storage area networks (SANs), direct-attached storage (DAS) and distributed DAS, as well as combinations of these and other storage types, including software-defined storage.

Also associated with the dynamic request processing system 105 are one or more input-output devices, which illustratively comprise keyboards, displays or other types of input-output devices in any combination. Such input-output devices can be used, for example, to support one or more user interfaces to the dynamic request processing system 105, as well as to support communication between dynamic request processing system 105 and other related systems and devices not explicitly shown.

Additionally, the dynamic request processing system 105 in the FIG. 1 embodiment is assumed to be implemented using at least one processing device. Each such processing device generally comprises at least one processor and an associated memory, and implements one or more functional modules for controlling certain features of the dynamic request processing system 105.

More particularly, the dynamic request processing system 105 in this embodiment can comprise a processor coupled to a memory and a network interface.

The processor illustratively comprises a microprocessor, a microcontroller, an application-specific integrated circuit (ASIC), a field-programmable gate array (FPGA) or other type of processing circuitry, as well as portions or combinations of such circuitry elements.

The memory illustratively comprises random access memory (RAM), read-only memory (ROM) or other types of memory, in any combination. The memory and other memories disclosed herein may be viewed as examples of what are more generally referred to as “processor-readable storage media” storing executable computer program code or other types of software programs.

One or more embodiments include articles of manufacture, such as computer-readable storage media. Examples of an article of manufacture include, without limitation, a storage device such as a storage disk, a storage array or an integrated circuit containing memory, as well as a wide variety of other types of computer program products. The term “article of manufacture” as used herein should be understood to exclude transitory, propagating signals. These and other references to “disks” herein are intended to refer generally to storage devices, including solid-state drives (SSDs), and should therefore not be viewed as limited in any way to spinning magnetic media.

The network interface allows the dynamic request processing system 105 to communicate over the network 104 with the user devices 102 and/or the one or more request management systems 120, and illustratively comprises one or more conventional transceivers.

The one or more request management systems 120 can comprise applications and/or services used for managing requests (e.g., related to acquiring and/or modifying a subscription) from user devices 102. For example, the one or more request management systems 120 can include one or more of the following: applications that enable users to create and modify data related to one or more configurable items; one or more order management application; one or more provisioning applications, one or more licensing applications, one or more finance applications, and/or other applications related to managing such configurable items. In at least one embodiment, the one or more request management systems 120 can correspond to systems and/or applications related to a legacy order flow, as described in more detail elsewhere herein.

The dynamic request processing system 105 further comprises an action derivation module 112, a processing object generation module 114, a processing object injection module 116, and a processing object execution module 118.

Generally, the action derivation module 112 obtains a dynamic request (e.g., from user device 102-1). The action derivation module 112 applies one or more rules (e.g., one or more of the processing rules 107) to derive one or more actions. For example, the actions can relate to subscribing, upgrading, downgrading, expanding, reducing, and/or adding or removing features related to a configurable item.

The processing object generation module 114 obtains the actions from the action derivation module 112, and applies one or more rules (e.g., one or more of the processing rules 107), to create instructions and/or data related to the actions. Accordingly, the processing rules 107, in some embodiments, can include a first set of rules for deriving a set of actions, and a second set of rules for deriving a set of data and/or instructions for each of the actions. The processing object generation module 114 also generates a processing object for the dynamic request that includes the information derived by the action derivation module 112 and the processing object generation module 114. The processing object can correspond to a file, and can be stored in the at least one database 106 as one of the processing objects 108.

The processing object injection module 116, in some embodiments, can identify one or more applications (e.g., related to one or more request management systems 120) impacted by a given action based on the processing object. The processing object injection module 116 can then notify the identified applications about the actions embedded in the processing object. As an example, the processing object injection module 116 can provide the identified applications with information that an identifier associated with the request (e.g., an order number).

The identified applications can call (e.g., via an application programming interface (API)) the processing object execution module 118 to execute the actions. The processing object execution module 118 obtains the processing object created for the dynamic requests, and executes the corresponding actions.

It is to be appreciated that this particular arrangement of elements 112, 114, 116, and 118 illustrated in the dynamic request processing system 105 of the FIG. 1 embodiment is presented by way of example only, and alternative arrangements can be used in other embodiments. For example, the functionality associated with the elements 112, 114, 116, and 118 in other embodiments can be combined into a single element, or separated across a larger number of elements. As another example, multiple distinct processors can be used to implement different ones of the elements 112, 114, 116, and 118 or portions thereof.

At least portions of elements 112, 114, 116, and 118 may be implemented at least in part in the form of software that is stored in memory and executed by a processor.

It is to be understood that the particular set of elements shown in FIG. 1 for dynamic request processing system 105 involving user devices 102 of computer network 100 is presented by way of illustrative example only, and in other embodiments additional or alternative elements may be used. Thus, another embodiment includes additional or alternative systems, devices and other network entities, as well as different arrangements of modules and other components. For example, in at least one embodiment, one or more of the dynamic request processing system 105, database(s) 106, and/or the one or more other systems and/or services 120 can be on and/or part of the same processing platform.

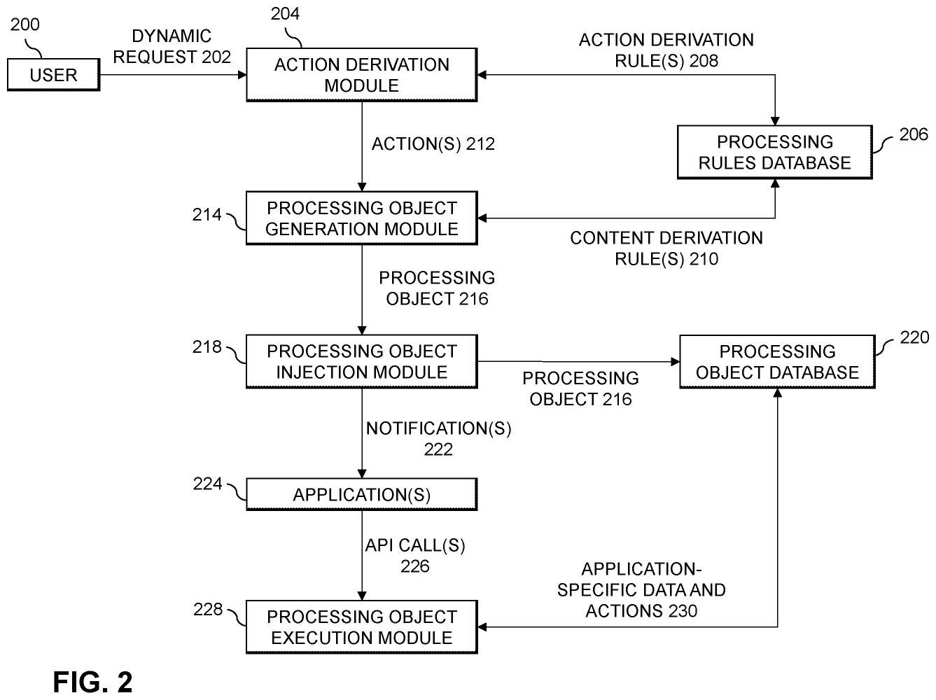

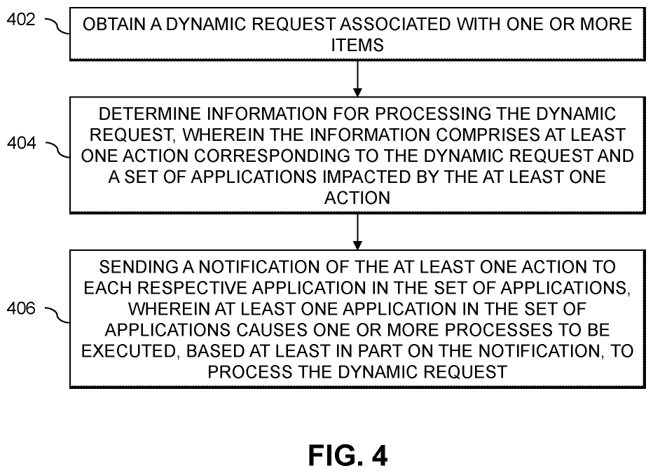

An exemplary process utilizing elements 112, 114, 116, and 118 of an example dynamic request processing system 105 in computer network 100 will be described in more detail with reference to, for example, FIGS. 2 and 4.

FIG. 2 shows an example system architecture for automated processing of dynamic request in an illustrative embodiment. More particularly, the system architecture includes a user 200 (e.g., corresponding to user device 102-1) that initiates a dynamic request 202 with an action derivation module 204. In some embodiments, the dynamic request 202 is based on one or more interactions of the user 200 with a web application, for example. As non-limiting examples, such interactions can include selecting, modifying, and/or canceling one or more features of a configurable item (e.g., a subscription). The action derivation module 204 obtains the dynamic request 202 and determines a context of the dynamic request 202. The action derivation module 204 then obtains or more action derivation rules 208 from a processing rules database 206 to derive one or more actions 212. Non-limiting examples of action derivation rules 208 include: “if selected offer is different than current offer and version is higher, then subscription action is upgrade; otherwise, subscription action is downgrade;” and “if quantity increased, then subscription action is add license.”

The actions 212 are obtained by a processing object generation module 214. The processing object generation module 214 applies one or more content derivation rules 210 from the processing rules database 206 to the actions 212. An example of a content derivation rule 210 is: “if subscription action is upgrade and offer type is “SAAS (SOFTWARE AS A SERVICE)” then add instruction for digital fulfilment and add remove quantity action for current offer.” The processing object generation module 214 generates a processing object 216 that includes the actions 212 and the information derived by applying the content derivation rules 210. The processing object 216 is sent to a processing object injection module 218.

The processing object injection module 218 stores the processing object 216 in a processing object database 220. The processing object injection module 218 also analyzes the processing object 216 to identify one or more applications 224 that are impacted by the dynamic request 202. The processing object injection module 218 sends notifications 222 to the identified applications 224. In some embodiments, the notifications 222 can include an indication that an order has been created for the dynamic request 202, and an indication of the actions 212 that are relevant to the respective applications 224.

When the order corresponding to the dynamic request 202 is received by a given one of the applications 224, then the given application 224 sends one or more API calls 226 to a processing object execution module 228. For a given one of the applications 224, the processing object execution module 228 retrieves the application-specific data and actions 230 from the processing object 216 stored in the processing object database 220. The processing object execution module 228 then executes the application-specific data and actions 230 for each of the applications 224.

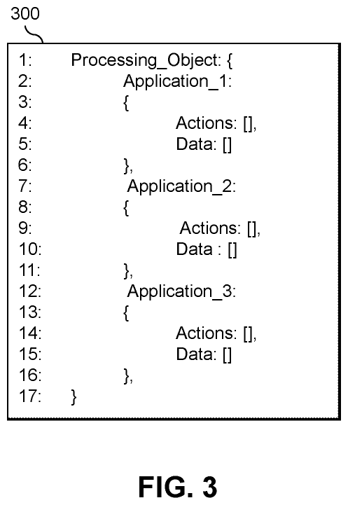

FIG. 3 shows an example of a processing object 300 in an illustrative embodiment. In this example, it is assumed that three applications (Application_1, Application_2, and Application_3) are affected by a dynamic request. Accordingly, the processing object 300 includes objects for each of these applications (e.g., the object for Application_1 is shown at lines 2-6 of the processing object 400). Each of these objects also includes the relevant actions and the corresponding data. For example, the lists (or arrays) shown at line 4 of processing object 300 can be populated with actions relevant to Application_1 (e.g., as derived by the action derivation module 204), and the list of data shown at line 4 of processing object 400 can be populated with data relevant to those actions (e.g., as derived by processing object generation module 214).

FIG. 4 is a flow diagram of a process for automated processing of dynamic requests in an illustrative embodiment. It is to be understood that this particular process is only an example, and additional or alternative processes can be carried out in other embodiments.

In this embodiment, the process includes steps 402 through 406. These steps are assumed to be performed by the dynamic request processing system 105 utilizing its elements 112, 114 and 116.

Step 402 includes obtaining a dynamic request associated with one or more items.

Step 404 includes determining information for processing the dynamic request, wherein the information comprises at least one action corresponding to the dynamic request and a set of applications impacted by the at least one action.

Step 406 includes sending a notification of the at least one action to each respective application in the set of applications, wherein at least one application in the set of applications causes one or more processes to be executed, based at least in part on the notification, to process the dynamic request.

The determining the information may include: applying one or more rules to the dynamic request to derive the at least one action and the one or more processes; and storing the determined information in a file corresponding to the dynamic request. The one or more processes may be executed by a service that is common to the set of applications, and the service may execute the one or more processes by retrieving the information stored in the file. The at least one application may cause the one or more processes to be executed using an application programming interface associated with the service. The process may further include the following steps: obtaining a further request; determining that the further request is not a dynamic request, wherein the further request is processed without using the service. The at least one action may include at least one of: creating a subscription, modifying a subscription, and canceling a subscription. A first process of the one or more processes may cause one or more changes to data, corresponding to the dynamic request, that is associated with a first application in the set of applications, and a second process of the one or more processes may make one or more changes to data, corresponding to the dynamic request, that is associated with a second application in the set of applications. The determining may include: determining the set of applications from among a plurality of applications of an organization corresponding to one or more of a product and a service associated with the dynamic request.

Accordingly, the particular processing operations and other functionality described in conjunction with the flow diagram of FIG. 4 are presented by way of illustrative example only, and should not be construed as limiting the scope of the disclosure in any way. For example, the ordering of the process steps may be varied in other embodiments, or certain steps may be performed concurrently with one another rather than serially.

The above-described illustrative embodiments provide significant advantages relative to conventional approaches. For example, some embodiments are configured to automatically process dynamic requests by deriving an object for a given dynamic request that is used to execute a plurality of actions across different applications and/or services to automatically process the dynamic request. These and other embodiments can effectively reduce the number of resources needed to process dynamic requests relative to conventional approaches.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

As mentioned previously, at least portions of the information processing system 100 can be implemented using one or more processing platforms. A given such processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one.

Some illustrative embodiments of a processing platform used to implement at least a portion of an information processing system comprises cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components, or portions thereof, are illustratively implemented for use by tenants of such a multi-tenant environment.

As mentioned previously, cloud infrastructure as disclosed herein can include cloud-based systems. Virtual machines provided in such systems can be used to implement at least portions of a computer system in illustrative embodiments.

In some embodiments, the cloud infrastructure additionally or alternatively comprises a plurality of containers implemented using container host devices. For example, as detailed herein, a given container of cloud infrastructure illustratively comprises a Docker container or other type of Linux Container (LXC). The containers are run on virtual machines in a multi-tenant environment, although other arrangements are possible. The containers are utilized to implement a variety of different types of functionality within the system 100. For example, containers can be used to implement respective processing devices providing compute and/or storage services of a cloud-based system. Again, containers may be used in combination with other virtualization infrastructure such as virtual machines implemented using a hypervisor.

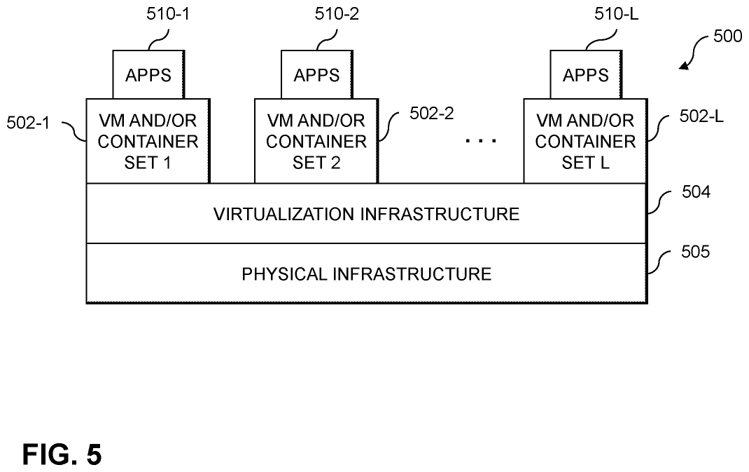

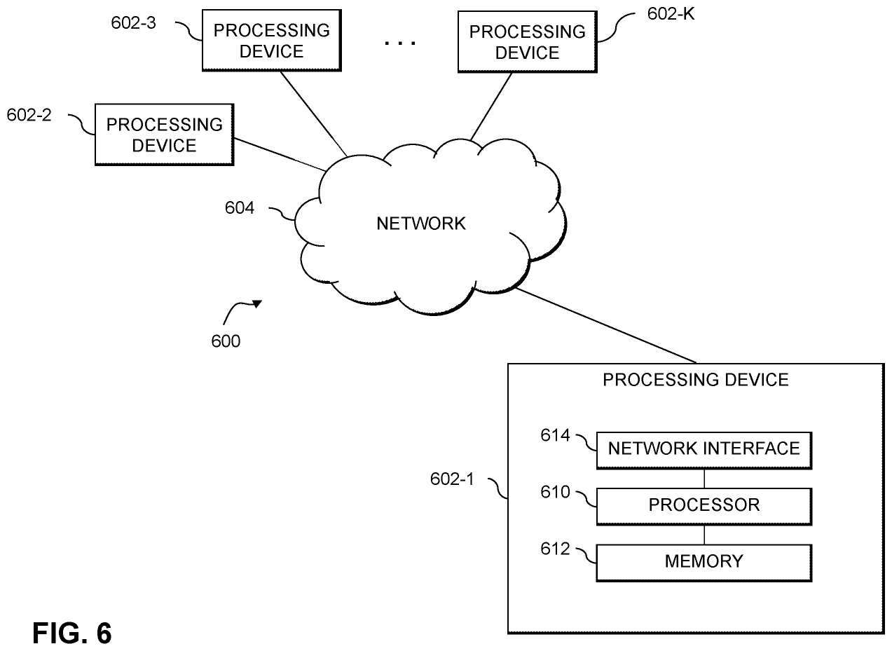

Illustrative embodiments of processing platforms will now be described in greater detail with reference to FIGS. 5 and 6. Although described in the context of system 100, these platforms may also be used to implement at least portions of other information processing systems in other embodiments.

FIG. 5 shows an example processing platform comprising cloud infrastructure 500. The cloud infrastructure 500 comprises a combination of physical and virtual processing resources that are utilized to implement at least a portion of the information processing system 100. The cloud infrastructure 500 comprises multiple virtual machines (VMs) and/or container sets 502-1, 502-2, . . . 502-L implemented using virtualization infrastructure 504. The virtualization infrastructure 504 runs on physical infrastructure 505, and illustratively comprises one or more hypervisors and/or operating system level virtualization infrastructure. The operating system level virtualization infrastructure illustratively comprises kernel control groups of a Linux operating system or other type of operating system.

The cloud infrastructure 500 further comprises sets of applications 510-1, 510-2, . . . 510-L running on respective ones of the VMs/container sets 502-1, 502-2, . . . 502-L under the control of the virtualization infrastructure 504. The VMs/container sets 502 comprise respective VMs, respective sets of one or more containers, or respective sets of one or more containers running in VMs. In some implementations of the FIG. 5 embodiment, the VMs/container sets 502 comprise respective VMs implemented using virtualization infrastructure 504 that comprises at least one hypervisor.

A hypervisor platform may be used to implement a hypervisor within the virtualization infrastructure 504, wherein the hypervisor platform has an associated virtual infrastructure management system. The underlying physical machines comprise one or more distributed processing platforms that include one or more storage systems.

In other implementations of the FIG. 5 embodiment, the VMs/container sets 502 comprise respective containers implemented using virtualization infrastructure 504 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 may each run on a computer, server, storage device or other processing platform element. A given such element is viewed as an example of what is more generally referred to herein as a “processing device.” The cloud infrastructure 500 shown in FIG. 5 may represent at least a portion of one processing platform. Another example of such a processing platform is processing platform 600 shown in FIG. 6.

The processing platform 600 in this embodiment comprises a portion of system 100 and includes a plurality of processing devices, denoted 602-1, 602-2, 602-3, . . . 602-K, which communicate with one another over a network 604.

The network 604 comprises any type of network, including by way of example a global computer network such as the Internet, a WAN, a LAN, a satellite network, a telephone or cable network, a cellular network, a wireless network such as a Wi-Fi or WiMAX network, or various portions or combinations of these and other types of networks.

The processing device 602-1 in the processing platform 600 comprises a processor 610 coupled to a memory 612.

The processor 610 comprises a microprocessor, a microcontroller, an ASIC, an FPGA or other type of processing circuitry, as well as portions or combinations of such circuitry elements.

The memory 612 comprises RAM, ROM or other types of memory, in any combination. The memory 612 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture comprises, for example, a storage array, a storage disk or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 602-1 is network interface circuitry 614, which is used to interface the processing device with the network 604 and other system components, and may comprise conventional transceivers.

The other processing devices 602 of the processing platform 600 are assumed to be configured in a manner similar to that shown for processing device 602-1 in the figure.

Again, the particular processing platform 600 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LXCs.

As another example, portions of a given processing platform in some embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage products or devices, or other components are possible in the information processing system 100. Such components can communicate with other elements of the information processing system 100 over any type of network or other communication media.

For example, particular types of storage products that can be used in implementing a given storage system of a distributed processing system in an illustrative embodiment include all-flash and hybrid flash storage arrays, scale-out all-flash storage arrays, scale-out NAS clusters, or other types of storage arrays. Combinations of multiple ones of these and other storage products can also be used in implementing a given storage system in an illustrative embodiment.

It should again be emphasized that the above-described embodiments are presented for purposes of illustration only. Many variations and other alternative embodiments may be used. Also, the particular configurations of system and device elements and associated processing operations illustratively shown in the drawings can be varied in other embodiments. Thus, for example, the particular types of processing devices, modules, systems and resources deployed in a given embodiment and their respective configurations may be varied. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A computer-implemented method comprising:
obtaining a dynamic request associated with one or more items;
determining information for processing the dynamic request, wherein the information comprises at least one action corresponding to the dynamic request and a set of applications impacted by the at least one action; and
sending a notification of the at least one action to each respective application in the set of applications, wherein at least one application in the set of applications causes one or more processes to be executed, based at least in part on the notification, to process the dynamic request;
wherein the method is performed by at least one processing device comprising a processor coupled to a memory.

2. The computer-implemented method of claim 1, wherein the determining the information comprises:
applying one or more rules to the dynamic request to derive the at least one action and the one or more processes; and
storing the determined information in a file corresponding to the dynamic request.

3. The computer-implemented method of claim 2, wherein the one or more processes are executed by a service that is common to the set of applications, and wherein the service executes the one or more processes by retrieving the information stored in the file.

4. The computer-implemented method of claim 3, wherein the at least one application causes the one or more processes to be executed using an application programming interface associated with the service.

5. The computer-implemented method of claim 2, further comprising:
obtaining a further request;
determining that the further request is not a dynamic request, wherein the further request is processed without using the service.

6. The computer-implemented method of claim 1, wherein the at least one action comprises at least one of: creating a subscription, modifying a subscription, and canceling a subscription.

7. The computer-implemented method of claim 1, wherein a first process of the one or more processes causes one or more changes to data, corresponding to the dynamic request, that is associated with a first application in the set of applications, and a second process of the one or more processes makes one or more changes to data, corresponding to the dynamic request, that is associated with a second application in the set of applications.

8. The computer-implemented method of claim 1, wherein the determining comprises:
determining the set of applications from among a plurality of applications of an organization corresponding to one or more of a product and a service associated with the dynamic request.

9. A non-transitory processor-readable storage medium having stored therein program code of one or more software programs, wherein the program code when executed by at least one processing device causes the at least one processing device:
to obtain a dynamic request associated with one or more items;
to determine information for processing the dynamic request, wherein the information comprises at least one action corresponding to the dynamic request and a set of applications impacted by the at least one action; and
to send a notification of the at least one action to each respective application in the set of applications, wherein at least one application in the set of applications causes one or more processes to be executed, based at least in part on the notification, to process the dynamic request.

10. The non-transitory processor-readable storage medium of claim 9, wherein the determining the information comprises:
applying one or more rules to the dynamic request to derive the at least one action and the one or more processes; and
storing the determined information in a file corresponding to the dynamic request.

11. The non-transitory processor-readable storage medium of claim 10, wherein the one or more processes are executed by a service that is common to the set of applications, and wherein the service executes the one or more processes by retrieving the information stored in the file.

12. The non-transitory processor-readable storage medium of claim 11, wherein the at least one application causes the one or more processes to be executed using an application programming interface associated with the service.

13. The non-transitory processor-readable storage medium of claim 10, further comprising:
to obtain a further request;
to determine that the further request is not a dynamic request, wherein the further request is processed without using the service.

14. The non-transitory processor-readable storage medium of claim 9, wherein the at least one action comprises at least one of: creating a subscription, modifying a subscription, and canceling a subscription.

15. An apparatus comprising:
at least one processing device comprising a processor coupled to a memory;
the at least one processing device being configured:
to obtain a dynamic request associated with one or more items;
to determine information for processing the dynamic request, wherein the information comprises at least one action corresponding to the dynamic request and a set of applications impacted by the at least one action;
to send a notification of the at least one action to each respective application in the set of applications, wherein at least one application in the set of applications causes one or more processes to be executed, based at least in part on the notification, to process the dynamic request.

16. The apparatus of claim 15, wherein the determining the information comprises:
applying one or more rules to the dynamic request to derive the at least one action and the one or more processes; and
storing the determined information in a file corresponding to the dynamic request.

17. The apparatus of claim 16, wherein the one or more processes are executed by a service that is common to the set of applications, and wherein the service executes the one or more processes by retrieving the information stored in the file.

18. The apparatus of claim 17, wherein the at least one application causes the one or more processes to be executed using an application programming interface associated with the service.

19. The apparatus of claim 16, wherein the at least one processing device is further configured:
to obtain a further request;
to determine that the further request is not a dynamic request, wherein the further request is processed without using the service.

20. The apparatus of claim 15, wherein the at least one action comprises at least one of: creating a subscription, modifying a subscription, and canceling a subscription.
